(19) United States
(12) Patent Application Publication
(10) Pub. No.: US 2009/0322685 A1
(43) Pub. Date: Dec. 31, 2009

(54) Computer input device using touch switch

(76) Inventor: Moon Key Lee, Seoul (KR)

Correspondence Address: BERLINER & ASSOCIATES, 555 WEST FIFTH STREET, 31ST FLOOR, LOS ANGELES, CA, 90013, US

(21) Appl. No.: 11/919,169

(22) PCT Filed: Apr. 17, 2006
(86) PCT No.: PCT/KR2006/001401

§ 371 Date: Sep. 1, 2009

(30) Foreign Application Priority Data
Apr. 27, 2005 (KR) 10-2005-0035016
May 6, 2005 (KR) 10-2005-0037935
Nov. 22, 2005 (KR) 10-2005-0111753
Feb. 13, 2006 (KR) 10-2006-0013785
Apr. 11, 2006 (KR) 10-2006-0032603

(51) Int. Cl. G06F 3/041

(52) U.S. Cl. 345/173

(57) ABSTRACT

Input device of computer using touch switch. Electronic signal flows between touching conducting pads. The microcontroller in main portion detects the said electronic signal and recognizes which pads are touched to generate the input signal. The pad portion may further contain acceleration sensor and in this case the microcontroller recognizes the touching impact strength of pad by analyzing the output of acceleration sensor to generate input signal. The input signal of touching pad and the touching impact strength generated by microcontroller can be transmitted to outer system like PC by communication portion in main portion.

### TECHNICAL FIELD

The present invention relates to input device of computer, and more particularly, by detecting the touching state between conducting pads and detecting the impact strength of the touching pads, input signal assigned to the pair of touching pads and the impact strength is generated.

### DISCLOSURE OF INVENTION

### Technical Problem

In general, The conventional input device of computer includes keyboard or mouse. They are designed for desktop computer. In other words, We can not use them for wearable computer. For PDA or smart phone, there are compact keypad or pointing device like stylus pen on touch screen of PDA. We have to concentrate to operate them because the key density is so high and the touch screen for stylus pen is so small. So it is very difficult to use them when we are running or driving. In other words, we have to look at the input device for correct input operation.

### Technical Solution

To solve the problem, it is an object of the present invention to provide an input device of computer which is wearable and it does not require high concentration. By using the present invention, We can even do the input operation without looking at the input device when we are running. The present invention can be made of flexible conducting pad so it does not require expensive die casting for case like the conventional keyboard. The present invention can be used for wearable computer with NED (near eye display) for doctors in emergency room in hospital, fire fighter, police officer or soldier.

### BRIEF DESCRIPTION OF THE DRAWINGS

FIG. 1 is the appearance of composition of present invention.

FIG. 2 is the circuit of embodiment 1.

FIG. 3 is the timing chart of output port of microcontroller.

FIG. 4 is the circuit of embodiment 2.

FIG. 5 is the circuit of embodiment 3.

FIG. 6 is the flow chart to detect the touching pad by using the output signal of FIG. 2

FIG. 7 is the composition of non glove pad of texture type.

FIG. 8 is the usage of inputting the coordinate by using the non glove pad of texture type.

FIG. 9 is the circuit of embodiment 4.

FIG. 10 is the composition of embodiment 5.

FIG. 11 is the circuit of embodiment 5.

FIG. 12 is the appearance of keyboard of embodiment 5.

FIG. 13 is the composition of embodiment 6.

FIG. 14 is the composition of embodiment 7.

FIG. 15 is the composition of embodiment 8.

FIG. 16 is the composition of embodiment 9.

FIG. 17 is the more specific composition of embodiment 9.

FIG. 18 is the composition of embodiment 10.

FIG. 19 is the composition of embodiment 11.

FIG. 20 is the composition of embodiment 12.

### SYMBOLS IN FIGURES

M,M1,M2: main portion PuR: pad on the back of the right hand PuL: pad on the back of the left hand
PdR: pad on the palm of right hand
PdL: pad on the palm of left hand
Pc: pad on knee
W: electric wire CM: communication portion
t1: time when the pads start touching.
t2: time when the pads stop touching.
Pm: conducting pad of texture type
Rg: right glove portion
Lg: left glove portion Mi: micro controller
Vcc: power (5V) Tp: thin non conducting tape
Ct: conducting coating material
Pf: conducting pad on the tip of finger or stylus pen
Cp,Cpx,Cpy: wired conducting pad
Dp: wireless conducting pad
Rv: RF reception portion Re: touch recognizing portion
Wa: RF transmission portion AC: alternating current power
R: resistor Addr,Addr1,Addr2: address signal
Mux,Mux1,Mux2,Mux3,Mux4: analog multiplexer
NG1,NG2: not gate CkTx: operation mode transmission portion
CkRx: operation mode receiver portion Cdp,Dpd,Npd: conducting pad
gen: signal generator recog: signal recognizing portion
Flt: band pass filter

### BEST MODE FOR CARRYING OUT THE INVENTION

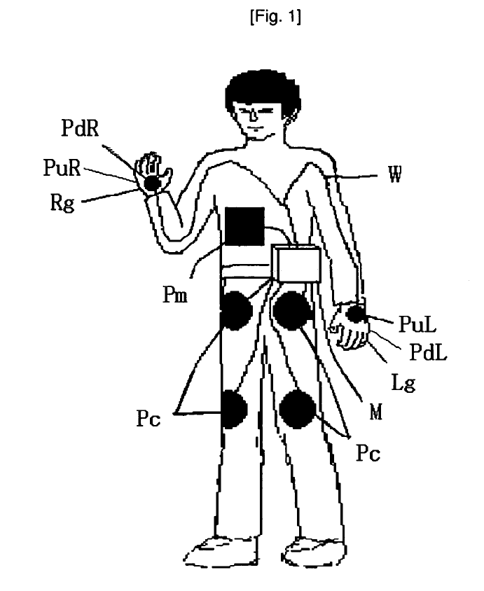

The present invention can be classified into wired mode, wireless mode and semi wireless mode. The wired mode is composed of main portion, pad portion as shown in FIG. 1. The main portion includes microcontroller and the pad portion includes the conducting pads which are connected by electric wire to the I/O port of microcontroller in main portion. The wireless mode uses the radio wave instead of electric wire between some pads and I/O port of microcontroller. The semi wireless mode includes the recognizer of electrical signal instead of the electric wire between some pads and the I/O port of microcontroller.

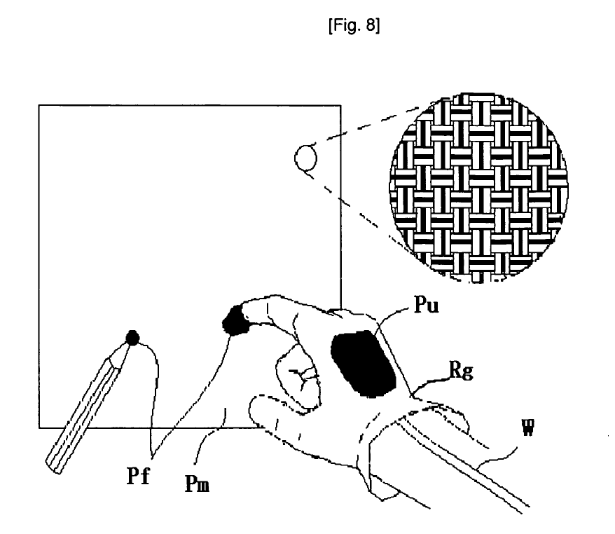

The pad portion includes at least two of right hand glove pad portion, left hand glove portion and non glove portion. The shape of right and left hand glove portion can be wearable glove type or stylus pen type. The non glove portion can be classified into the terminal type and texture type. The terminal type pad is big one conducting pad and the texture type pad is a texture of electric wire as shown in FIG. 7. Each electric wire in FIG. 7 is insulated. The electric wire of texture in FIG. 7 is a non conducting tape whose one side is coated with conducting material.

The man in FIG. 1 is wearing the example of present invention including conducting pad (PdR) on palm of right hand glove, the conducting pad (PuR) on the back of the hand of right hand glove, conducting pad (PdL) on palm of left hand glove, and the conducting pad (PuL) on the back of the hand of left hand glove. The conducting pad (Pc) of non glove portion (Ng) in FIG. 1 is attached on the leg and the texture type conducting pad (Pm) of non glove portion is attached on stomach. The main portion (M) may further include the communication portion. The communication portion can be serial port interface, usb interface or Bluetooth interface. The communication portion can be omitted if the microcontroller operates as small computer. The man in FIG. 1 can do the key input operation by clapping or touching with the glove of conducting pads (PdL, PuL, PdR, PuR) and can do the pointing operation by touching the texture type non glove pad (Pm) with the conducting tip (Pf) of stylus pen as shown in FIG. 8. The conducting pads (PdL, PuL, PdR, PuR, Pc) can be made of metal plate, metal spring, conducting rubber, or conducting cloth. The electrical signal flows from one conducting pad to another when the user claps with the glove of the conducting pads and the microcontroller (Mi) detects the touching of conducting pads by monitoring its I/O port. The input key or mouse signal assigned to the detected pair of touching conducting pads can be transmitted to the other device by communication portion. The input signal can be the signal of keyboard, mouse, joystick or some customized device. The communication portion can be removed if the microcontroller of main portion operate as computer.

The wireless mode of the present invention uses the radio wave to connect some conducting pads with the main portion. The semi wireless mode does not use the radio wave but uses the recognizer of electric signal in order to eliminate the electric wire.

### MODE FOR THE INVENTION

### Embodiment 1

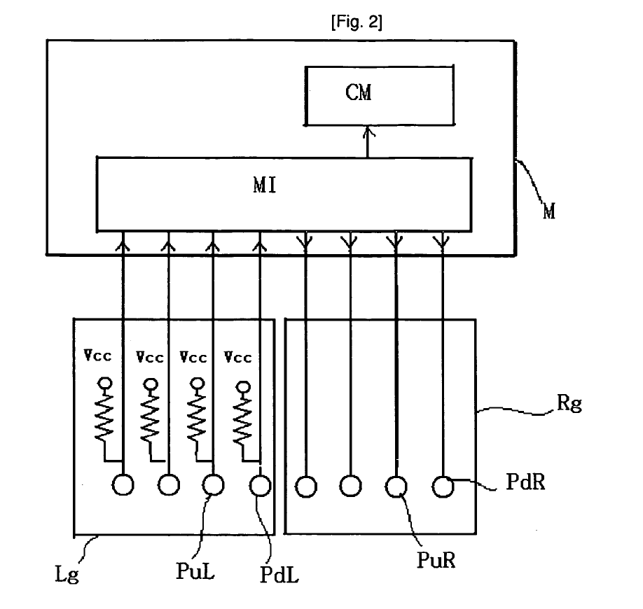

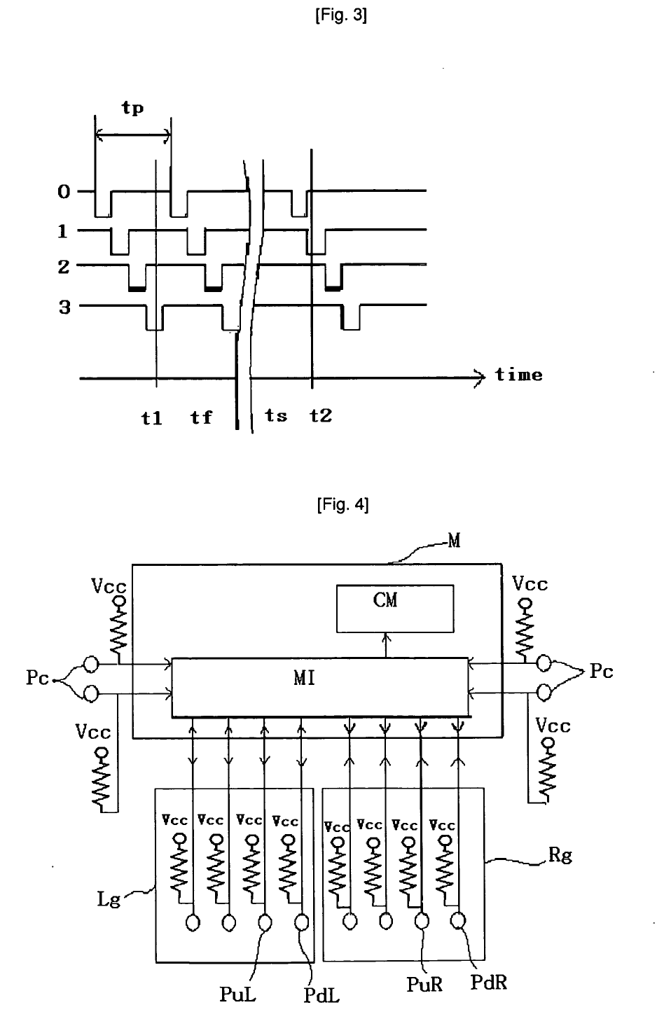

This embodiment explains how the microcontroller (MI) detects the touching pads when the electric signal flows from right hand glove portion (Rg) to left hand glove portion (Lg) as shown in FIG. 2. All input ports of microcontroller are shown as arrows toward the microcontroller and the all output ports of microcontroller are shown as the arrow from the microcontroller.

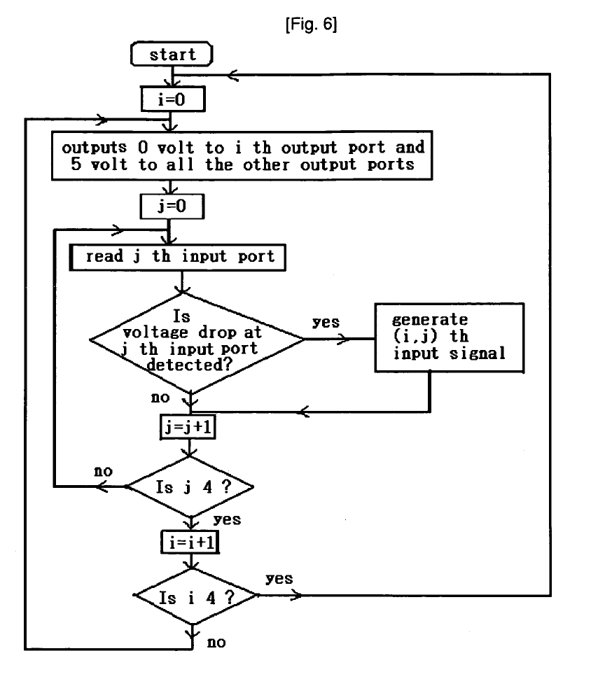

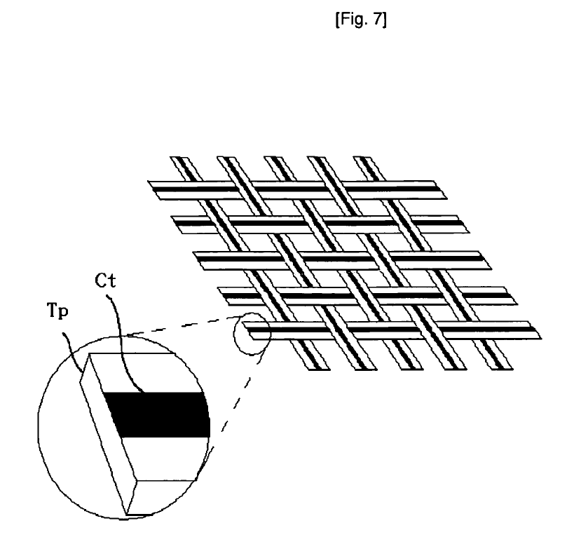

In FIG. 2, input ports of microcontroller are connected with 4 conducting pads (PdL, PuL). Power voltage (Vcc) is applied to the conducting pads (PdL, PuL) with pull up resistors. The microcontroller repeats the outputting the scanning signals to the output ports and at the same time, repeats the reading the 4 input ports. The outputting the scanning signals to the output ports means that the microcontroller outputs 0 volt to the only one output port and outputs high volt to the other output ports at a moment and the 0 volt outputted port rotates repeatedly. In other words, the index of output port of microcontroller whose output voltage is 0 increases from 0 to 3 and returns to 0 repeatedly. If an user who wears the gloves of conducting pads connected to I/O ports of the microcontroller claps, electrical signal flows from one pad of left hand glove to the touching pad of right hand glove and such a flow of signal can be detected by the microcontroller which is outputting the scanning signals to the output ports and reading the input ports. The flow chart of such a detection is shown in FIG. 6. The information about the detected touching pair of conducting pads can be transmitted by communication portion (CM) to PC, smart phone, PDA or electronic drum and the communication portion can be USB interface. The electronic drum can play drum sound in response to the clapping of user who wears the glove of present embodiment.

There are 4 conducting pads for left hand glove and also 4 conducting pads for right hand glove in this embodiment so 16 input signals can be generated. The number of conducting pads of glove is not limited to 4.

### Embodiment 2

The above embodiment 1 explained the case in which the conducting pads are attached to only glove portion (Lg,Rg). This embodiment contains not only the glove portion but also the non glove portion (Ng). For example, as show in FIG. 1 An user can do the input operation by touching pads (PdR,PuL) of glove to the pads (Pc) of knee. In this case, the pads (Pc) of knee is contained in non glove portion (Ng). The conducting pad (Pc) of non glove portion (Ng) can be connected to the input port or output port of microcontroller (MI). Such a 2 cases are equivalent and symmetric. The case as show in FIG. 4 will be explained in this embodiment. The conducting pads (Pc) of non glove portion are connected to the input ports of microcontroller (Mi) and the other pads (PdL, PuL, PdR, PuR) of left hand (Lg) and right hand (Rg) glove portions are connected to the bidirectional I/O ports of microcontroller (Mi) and all of the pads are applied by power voltage (Vcc) with pull up resistors as shown in FIG. 4. The pads of left and right glove portion must be connected to the bidirectional I/O port of microcontroller in order to detect the touching between pads of non glove portion and the pads of glove portion. In mode 1, the bidirectional I/O port of microcontroller which is connected to the conducting pads of left hand glove operates as the input port and the bidirectional I/O port of microcontroller which is connected to the conducting pads of right hand glove operates as the output port. In a moment, state of the microcontroller changes from mode 1 into mode 2 in which the bidirectional I/O port of microcontroller which is connected to the conducting pads of left hand glove operates as the output port and the bidirectional I/O port of microcontroller which is connected to the conducting pads of right hand glove operates as the input port. The state of microcontroller oscillates between mode 1 and mode 2 in order to detect the touching pads between glove portion (Lg,Rg) and non glove portion (Pc). The following is the more specific process of such a detection.

(0). Set the state of microcontroller as mode 1

(1). Assign serial index 0, 1, 2, . . . to all of the output ports of microcontroller and also assign the serial index 0, 1, 2, . . . to all of the input ports of microcontroller for the given mode. Set k=0,

(2). the microcontroller outputs the 0 volt to the k th output port and outputs 5 volt to the other output ports.

(3). The microcontroller reads all of the input ports.

(4). If the drop of voltage from the read value from any of the input ports occurs then select the index k of output port which is outputting the 0 volt and the index of input port at which the drop of voltage is detected and generates the keyboard or mouse button input signal corresponding to the pair of selected indices.

(5). Increase k by 1, If k is smaller than the number of output ports for the given mode, then repeat the above process (2)˜(5). Otherwise go to process (6). (6). If current state is mode 1 then change the state to mode2. If current state is mode 2 then change the state to mode1. repeat process (1)˜(6)

### Embodiment 3

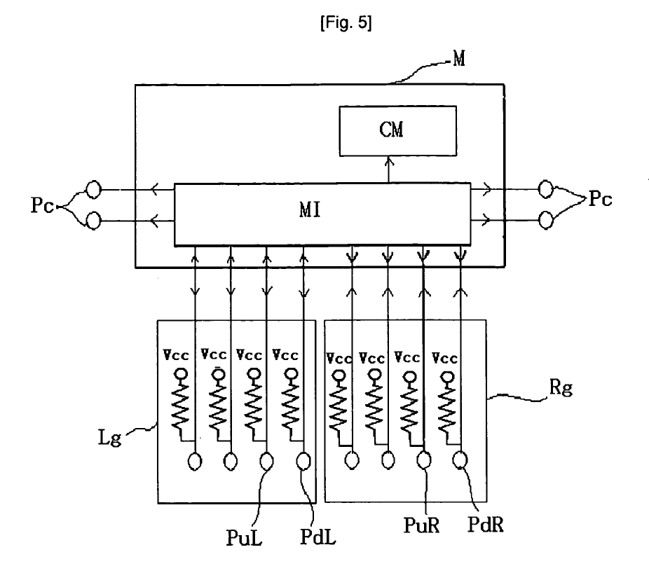

In this embodiment, the conducting pads (Pc) of non glove portion (Ng) are connected to the output ports of microcontroller (MI) as shown in FIG. 5. The other conducting pads (PdL, PuL, PdR, PuR) of left (Lg) and right (Rg) hand glove portion are connected to the bidirectional I/O ports of microcontroller with power voltage (Vcc) applied with pull up resistors. In other words, the only difference between the embodiment 2 and embodiment 3 is the connection between the pads of non glove portion and the I/O port of microcontroller. The process to detect the touching pads is the same as the embodiment 2.

### Embodiment 4

In this embodiment, the form of pads of non glove portion is not a terminal as in the above embodiments but a texture which can be used to generate 2 dimensional coordinate of mouse pointer with a stylus pen type pad of left or right hand glove portion. An user can move the mouse pointer by writing a character with the stylus pen type pad on the texture type pad. The terminal type pad (Pf) of left or right hand glove portion which is a stylus pen as shown in FIG. 8 is not connected to any of port of microcontroller. FIG. 7 shows the example of the texture type pad which is woven with insulating tape (Tp) coated with conducting material (Ct) on only one side. The FIG. 8 shows the inputting operation of 2 dimensional coordinate by touching the stylus pen type pad (Pf) with the conducting side (Ct) of texture type pad (Pm).

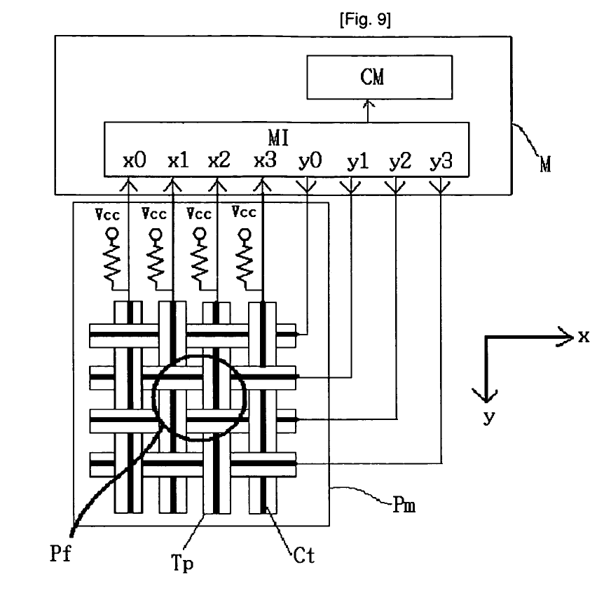

The FIG. 9 shows the I/O ports of microcontroller (Mi) is connected to the conducting line (Ct) coated on thin insulating tape of texture type pad in FIG. 7 and FIG. 8. The operation of circuit of FIG. 9 is almost the same as that of FIG. 2. In FIG. 2, the two pads touch each other directly but in FIG. 9, the two conducting lines (Ct) touch each other through the stylus pen type pad (Pf). If an user write a character on the texture type pad with the stylus pen type pad (Pf), then neighboring conducting lines (Ct) of the texture touch the stylus pen type pad (Pf) simultaneously so the electrical signal flows from the output port of microcontroller to the input port of microcontroller through the stylus pen type pad. For example, If two horizontal conducting lines (y1,y2) and two vertical conducting lines (x1,x2) are touching with the stylus pen type pad (Pf) as shown in FIG. 9, the microcontroller can detect the 4 touching pairs (x1,y1), (x1,y2), (x2,y1), (x2,y2) of vertical and horizontal conducting lines (Ct) of texture by scanning the I/O port with the algorithm shown in the FIG. 6. The coordinate of mouse pointer can be obtained by selecting the center of the 4 touching pair (x1,y1), (x1,y2), (x2,y1), (x2,y2) of vertical and horizontal conducting lines (Ct). More specifically, the coordinate system is as following: The horizontal line is x axis and the vertical line is the y axis as shown in FIG. 9 and the x coordinate value j is the sequential index of input port x0, x1, x2, . . . xj, . . . of microcontroller and the y coordinate value i is the index of output port y0, y1, y2, . . . , y1, . . . of microcontroller. In other words, the coordinate of the pairs of touching pads (x1,y1), (x1,y2), (x2,y1), (x2,y2) are (1,1), (1,2), (2,1), (2,2) respectively and their center value (1.5,1.5) is the coordinate of mouse pointer. In FIG. 9, the maximum number of input and output port is 4 but it is recommanded to select larger number for real mouse input operation.

The number of I/O port of microcontroller in any embodiment of the present invention is selected as small as possible to present clear and easy embodiment. The composition obtained by swapping the 0 volt and 5 volt and swapping the pull up and pull down resistor from the above embodiments are symmetric to the original embodiment and equivalent so the detail description is omitted here.

### Embodiment 5

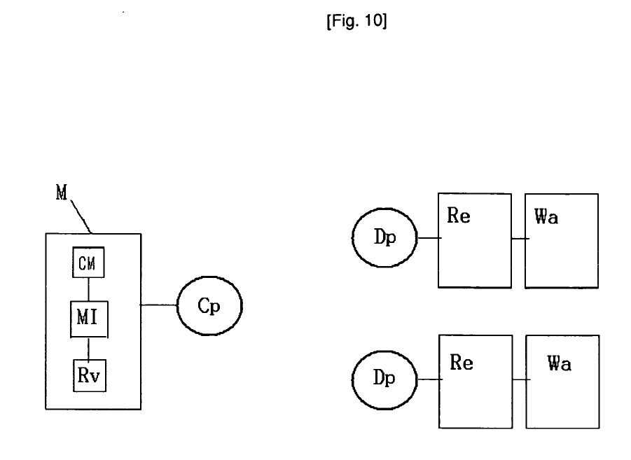

All of the above embodiments contain the electric wire between conducting pads and I/O ports of microcontroller to convey the electric signal. Such a wire is annoying for active user like sportsman or soldier. This embodiment presents how to replace some of the wires between conducting pads and I/O ports of microcontroller by the radio wave. In this embodiment as shown in FIG. 10, the conducting pads can be classified into two categories: the wired pads (Cp) in left hand glove portion connected to the main portion by electric wire and the RF pads (Dp) in right hand glove portion which are not connected to the main portion by electric wire but connected by radio wave. The main portion contains the microcontroller and communication portion (CM). The RF pad (Dp) is connected to the touch recognizing portion (Re) which recognizes the touching between RF pad (Dp) and the wired pad (Cp) and the touch recognizing portion (Re) is connected to the RF transmission portion (Wa) which transmits the ID information of the RF pad by radio wave in response to the touching between wired pad (Cp) and the RF pad (Dp).

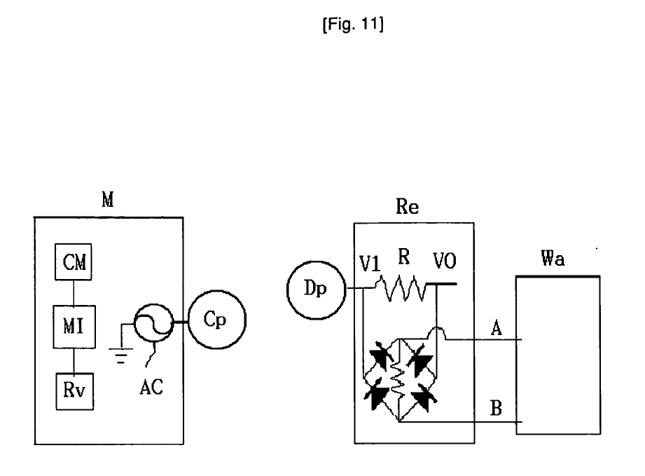

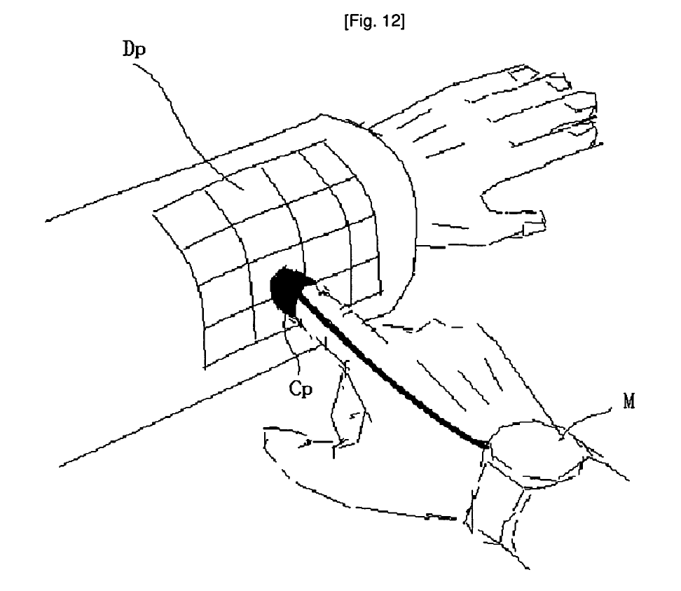

The right hand glove portion includes a plurality of pad units. The pad unit is the serially connected set of RF pad (Dp), touch recognizing portion (Re) and RF transmission portion (Wa). The main portion (M) contains the RF receiver portion (Rv) which can receives the radio wave from the said RF transmission portion (Wa) and interprets the ID of the RF pad from the received radio wave. The microcontroller (Mi) generates keyboard or mouse button signal corresponding to the ID of touched RF pad. The keyboard or mouse button signal can be transmitted to PC or PDA by the communication portion (CM). The communication between the RF transmission portion (Wa) and the RF receiver portion (Rv) can be bluetooth or wireless LAN, etc. There are many examples of touch switch like touch switch of elevator or touch switch of electric lamp which change state from off to on when an user touch the switch plate by finger. The touch switch changes the state from off to on by detecting the change of voltage or capacitance which can be induced by touching not only finger but also any conducting material. In this embodiment, It is recommended to use more stable touch switch as shown in FIG. 11 which changes its state by detecting the touch only between wired pad (Cp) and the RF pad (Dp). The wired pad (Cp) in main portion is applied alternating current (AC) and the RF pad (Dp) is connected to the touch recognizing portion (Re) which can recognize the alternating current by rectifying the alternating current between the two terminals (V0,V1) of resistor (R) which is connected to the RF pad (Dp). When the wired pad (Cp) touches the RF pad (Dp), the output voltage between two terminals (A,B) of rectifying circuit changes from 0 volt to positive non zero volt. Such a non zero voltage between two terminals (A,B) is used as power to the RF transmission portion (Wa) which transmits radio wave of ID of the RF pad (Dp). FIG. 12 shows the wearable keyboard with which an user can input operation by touching wired pad (Cp) at the tip of finger and one of the RF pads (Dp) of key pad at the sleeve. There is no annoying electric wire between RF pad (Dp) on left sleeve and the main portion (M) on right hand wrist.

### Embodiment 6

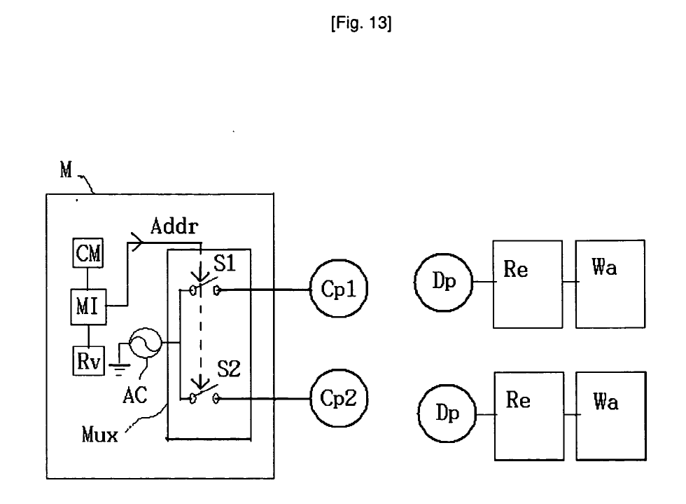

The circuit of FIG. 13 can be obtained by adding multiple wired pads (Cp1, Cp2) connected to the main portion. More specifically, the two wired pads (Cp1, Cp2) are contained in left hand glove portion and the RF pads (Dp) are contained in the right hand glove portion. The right hand glove portion in FIG. 13 contains two pad units. Each pad unit contains serially connected set of RF pad (Dp), touch recognizing portion (Re) and RF transmission portion (Wa). One pad is attached on the palm of glove and the other pad is attached on the back of the hand of glove. An user can do the input operation by clapping with glove. Total number of key signal is 4 because of 2 pads on the left hand glove and 2 of right hand glove.

They are:

(palm of left hand, palm of right hand),

(palm of left hand, back of right hand),

(back of left hand, palm of right hand),

(back of left hand, back of right hand)

If there are N pads on left and right hand glove respectively then the total number of input signal is N×N. The alternating current (AC) is periodically applied to each wired pad (Cp) through analog multiplexer whose inner switches are controlled by the address signal of the microcontroller (Mi). More specifically, The address signal of microcontroller oscillates between 1 and 2. If the address signal is 1 then the 1st switch (S1) in the analog multiplexer is on and all the other switches are off so that only the 1st wired pad (Cp1) is applied with the alternating current (AC) and if the address signal is 2 then the 2nd switch (S2) in the analog multiplexer is on and all the other switches are off so that only the 2nd wired pad (Cp2) is applied with the alternating current (AC). An user can do the input operation by clapping with the glove of such wired pads (Cp) and the RF pads (Dp). The detail process of input operation is following:

(1). Microcontroller outputs address signal so that the alternating current (AC) is applied only to the 1st wired pad (Cp1) of left hand glove portion.

(2). If the RF receiver portion (Rv) of left hand glove portion detect any radio wave from the RF transmission portion (Wa) of right hand glove portion then microcontroller generate the key input signal corresponding to the pair (Cp1,ID) of touching pads which are the wired pad (Cp1) applied with the alternating current and the ID of RF pad interpreted from the radio wave.

(3). Microcontroller changes the address signal so that the alternating current (AC) is applied only to the 2nd wired pad (Cp2) of left hand glove portion.

(4). If the RF receiver portion (Rv) of left hand glove portion detect any radio wave from the RF transmission portion (Wa) of right hand glove portion then microcontroller generate the key input signal corresponding to the pair (Cp2,ID) of touching pads which are the wired pad (Cp2) applied with the alternating current and the ID of RF pad interpreted from the radio wave.

(5). Repeat the above process (1)˜(5)

The above process of 2×2 pads for left and right hand glove can be generalized to the N×M pads for left and right hand glove as following: Let Cp1, Cp2, . . . Cpn be the N wired pads of left hand glove portion and let Dp1, Dp2, . . . , DpM be the M RF pads for right hand glove portion. Then the detail process is as following:

(1). assign 1 to i which is the serial index of wired pad (Cpi) of left hand glove portion. (i=1, 2, 3, . . . N)

(2). apply the alternating current (AC) only to the i th wired pad (Cpi)

(3). If radio wave is received then extract the index j of RF pad from the ID value of radio wave and generate the key input signal corresponding to the pair of index (i,j) of touching pads. (ID=1, 2, 3, . . . , M)

(4). increase i by 1

(5). if i is equal to N+1 then assign 1 to i.

(6). repeat the above process (2)˜(6).

### Embodiment 7

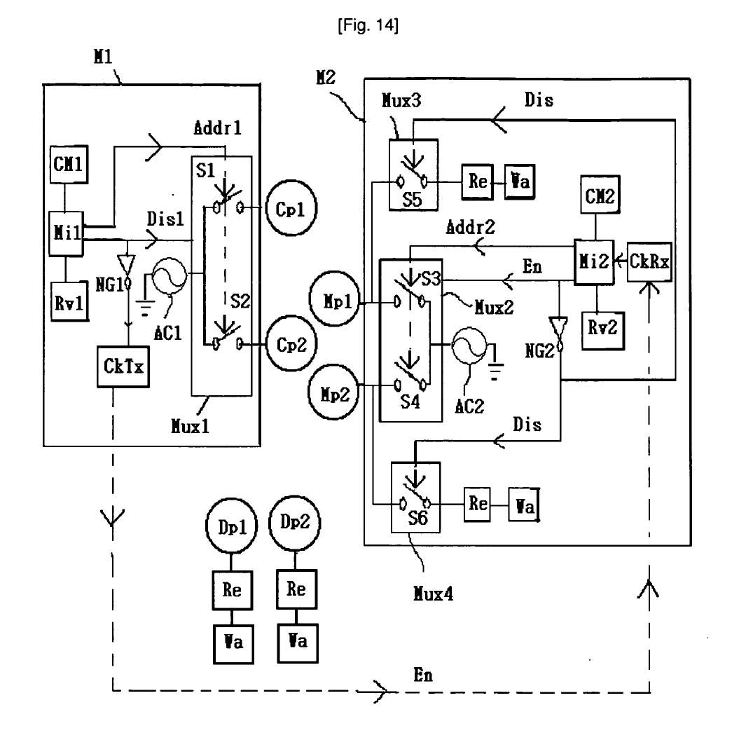

FIG. 14 shows how to add pads (Dp1,Dp2) of non glove portion to the embodiment 6. The pads in FIG. 14 can be classified into 3 categories: They are the Pads (Cp1, Cp2) of left hand glove portion, the pads (Mp1, Mp2) of right hand glove portion, and the pads (Dp1, Dp2) of non glove portion. The non glove portion contains a plurality of pad units. The pad unit is the serially connected set of RF pad (Dp), touch recognizing portion (Re) and RF transmission portion (Wa). In order to additionally detect the touching between the pads of glove portion and the pads of non glove portion, operation mode of the pads of right hand glove portion should oscillates between wired mode and RF mode where the pads in wired mode operate as wired pad and the pads in RF mode operate as RF pads.

The 1st main portion (M1) is connected to the pads (Cp1, Cp2) of left hand glove portion and the 2nd main portion (M2) is connected to pads (Mp1, Mp2) of the right hand glove portion and the pads (Dp1,Dp2) of non glove portion are attached to user's waist. The 1st microcontroller (Mi1) of 1st main portion (M1) controls the 1st analog multiplexer (Mux1) by outputting the enable/disable (Dis1) and address (Addr1) signal to the 1st analog multiplexer (Mux1). If the enable/disable signal (Dis1) is 5 volt then the analog multiplexer (Mux1) is enabled so that only one of switches in it is on state and If the enable/disable signal (Dis1) is 0 volt then all switches in it is off state. The switch of on state is determined by the address signal (Addr1) which changes periodically and rotates. Such enable/disable signal (Dis1) is inverted by the logic inverter gate (NG1) and transmitted as radio wave (En) by the operation mode transmission portion (CkTx) in order to synchronize the operation of 1st and 2nd main portion. The 2nd main portion (M2) contains the operation mode receiver portion (CkRx) which receives and interprets the radio wave (En) of operation mode signal. The interpreted operation mode signal (En) is transferred to the 2nd microcontroller (M2) from the operation mode receiver portion (CkRx). The operation mode signal (En) is used by 2nd microcontroller (M2) to enable or disable the 2nd analog multiplexer (Mux2) and its logically inverted operation mode signal (Dis) by logic inverter (NG2) is applied to the other analog multiplexers (Mux3, Mux4) which contain only one switch (S5,S6) respectively.

The 1st microcontroller (Mi1) changes the enable/disable (Dis1) signal periodically between 0 volt and 5 volt. In other words, the enable/disable (Dis1) signal changed like 0,5,0,5,0,5, If the enable/disable (Dis1) signal is 5 volt then operation mode received by the operation mode receiver portion (CkRx) is 0 volt and the 1st analog multiplexer (Mux1) is enabled and the 2nd analog multiplexer (Mux2) is disabled and the other analog multiplexers (Mux3, Mux4) of only one switch are enabled. It means that the pads (Mp1,Mp2) of right hand glove portion connected to the 2nd main portion (M2) operates as the RF pads.

In other case, the enable/disable (Dis1) signal is 0 volt then operation mode received by the operation mode receiver portion (CkRx) is 5 volt and the 1st analog multiplexer (Mux1) is disabled and the 2nd analog multiplexer (Mux2) is enabled and the other analog multiplexers (Mux3, Mux4) of only one switch are disabled. It means that the pads (Mp1,Mp2) of right hand glove portion connected to the 2nd main portion (M2) operates as the wired pads. In this case, pads (Cp1, Cp2) connected to the 1st analog multiplexer (Mux1) does not play any role because the 1st analog multiplexer (Mux1) is disabled.

During the 2nd analog multiplexer (Mux2) is enabled, the 2nd microcontroller (Mi2) periodically changes the address signal (Addr2) and at the same time, detects the touching between the pads (Mp1,Mp2) connected to the 2nd multiplexer (Mux2) and the pads (Dp1, Dp2) of non glove portion and generates the corresponding key input signal as described in the previous embodiment 6. More specifically, the 2nd RF receiver portion (Rv2) receives radio wave of ID of pad (Dp1 or Dp2) of non glove portion from the RF transmission portion (Wa) of non glove portion if the pads (Mp1,Mp2) connected to the 2nd multiplexer (Mux2) and the pads (Dp1, Dp2) of non glove portion touch. Then the 2nd microcontroller (Mi2) generates the key input signal corresponding the pair of touching pads.

Similarly, During the 1st analog multiplexer (Mux1) is enabled, the 1st microcontroller (Mi1) periodically changes the address signal (Addr1) and at the same time, detects the touching among pads as described in previous embodiment 6. In this case the pads can be classified into 2 categories: the wired pads (Cp1,Cp2) connected to the 1st analog multiplexer (Mux1) and the other RF pads (Mp1,Mp2,Dp1,Dp2). The 1st RF receiver portion (Rv1) receives radio wave from the RF transmission portion (Wa) connected to the RF pads (Mp1,Mp2,Dp1,Dp2) as described in the previous embodiment 6.

### Embodiment 8

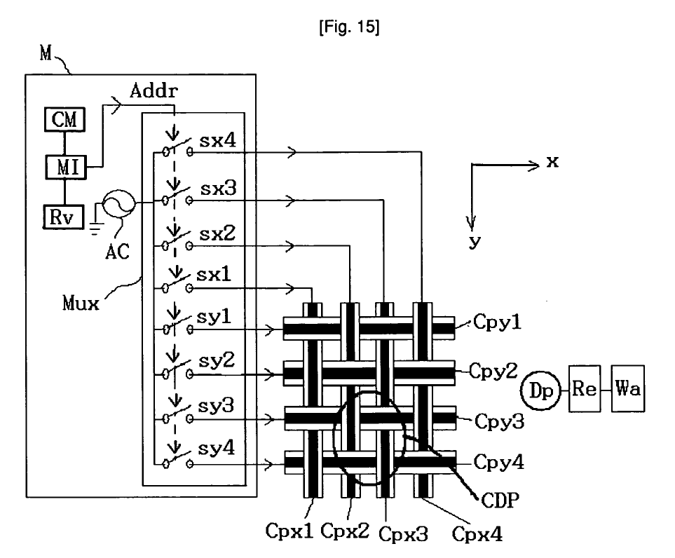

FIG. 15 shows the pointing device which is obtained by modifying the circuit in FIG. 13. There are many wired pads (Cpx1˜Cpx4,Cpy1˜Cpy4) in texture and one RF pad (Dp) in stylus pen type in FIG. 15. The texture is the same as in FIG. 7. The RF pad (Dp) is recommended to attached to the tip (Pf) of pen or finger as shown in FIG. 8. The touching region between the RF pad (Dp) and the texture is represented as circle (CDP) in FIG. 15. In the above embodiment 4, touching the texture with any conducting material induces the switching operation so unwanted key input signal may be generated if an user is surrounded by conducting materials. But in this embodiment, there is no such unwanted operation because of the stylus pen of RF pad.

In FIG. 15, thin conducting lines (Cpx1˜Cpx4,Cpy1˜Cpy4) coated on only one side of insulating tapes of texture are the wired pads connected to the analog multiplexer (Mux) and the common terminal of switch of the analog multiplexer (Mux) is connected to the alternating current source (AC). The microcontroller (Mi) in main portion (M) periodically changes the address signal (Addr) to the analog multiplexer so that the alternating current is applied to the only one wired pad. For example, There is N switches in the analog multiplexer, the address signal changes like 1, 2, 3 . . . , N, 1, 2, 3 . . . , N, 1, 2, 3 . . . , N, . . . and the corresponding switch whose state is on changes like S1, S2, S3 . . . , SN, S1, S2, S3 . . . , SN, S1, S2, S3 . . . , SN, . . . where Si means the i th switch. In FIG. 15, the switch which is connected to the wired pad Cpxi is represented as Sxi and the switch which is connected to the wired pad Cpyj is represented as Syj. The ‘i’ of wired pad Cpxi corresponds to the x coordinate (1˜4) of pointing device, and the ‘j’ of wired pad Cpyj corresponds to the y coordinate (1˜4) of pointing device. It is recommended to select larger number for maximum coordinate value than 4 in real implementation. The microcontroller (Mi) periodically change the address signal (Addr) so that only one of switch in the analog multiplexer is on and check at the same time whether radio wave is received by the RF receiver portion (Rv) or not. More specifically, The switch whose state is on may changes in time series like: Sx1, Sx2, Sx3, Sx4, Sy1, Sy2, Sy3, Sy4. Such a change of one period is called scanning. During the scanning If there is received radio wave from the RF transmission portion (Wa) connected to the stylus pen type RF pad (Dp) then the microcontroller records the indices of switches whose states are on to RAM. X or y coordinate value for mouse pointer can be obtained from the recorded indices because there is a one to one correspondence among the x coordinate i switch Sxi and the pad Cxi and similarly there is a one to one correspondence among the y coordinate j switch Syj and the pad Cyj. If the RF pad (Dp) touches the region (CDP) of circle in FIG. 15, then the RF receiver portion (Rv) detects the radio wave when the 4 switches sx2, sx3, sy3, sy4 are on state and the corresponding x coordinates 2, 3 and the y coordinate 3, 4 are obtained and by averaging the coordinate value, the coordinate of mouse pointer can be obtained. In other words, average value of x coordinate 2,3 is 2.5 and the average value of 3,4 is 3.5 therefore the coordinate of mouse pointer is (2.5, 3.5). After one period of scanning, all the recorded indices of switch are cleared and new scanning repeats. Such a scanning repeats typically 100 times or more per second.

### Embodiment 9

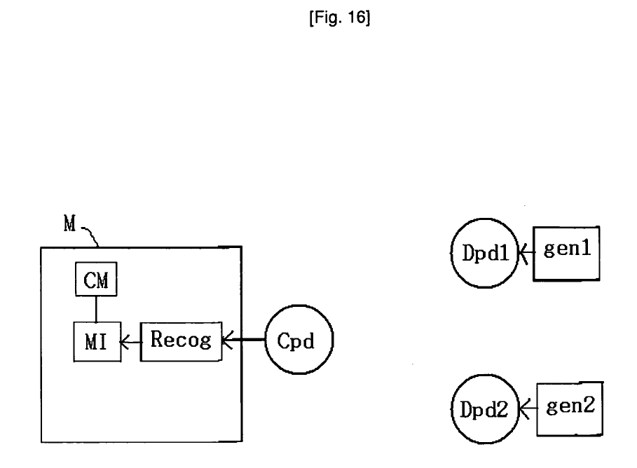

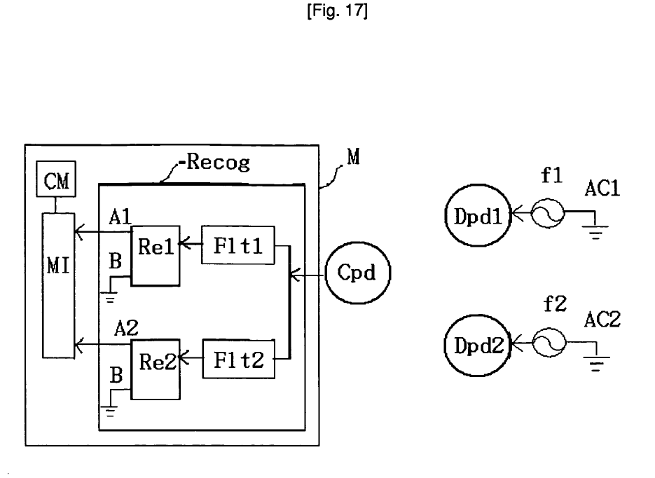

If two or more users use the input device of the previous embodiment 5˜8 in a small room then the jamming of radio wave may lower the efficiency of the operation of the present invention. From the present embodiment, the semi wireless mode of present invention is explained. The semi wireless mode can remove some wires between pads and the main portion without introducing such jamming. In FIG. 16 and the FIG. 17, the example of semi wireless mode contains the pad (Cpd) connected to the main portion (M) and a plurality of pad units. The pad unit is the serially connected set of conducting pad (Dpd1 or Dpd2) and the signal generators (gen1 or gen2). Each signal generator generates its own distinguishable signal. The two different signals of signal generators (gen1, gen2) may be alternating current of two different frequency f1,f2 as shown in FIG. 17. Such different signal of different frequency may be called frequency modulated signal and the other type of signals can also be used in this embodiment like the amplitude modulated, phase modulated, and code modulated, etc. The pads (Dpd1, Dpd2) connected to the signal generators (gen1,gen2) are contained in the right hand glove portion. For example, one of the pad (Dpd1) is attached to the palm of the right hand glove and the other pad (Dpd2) is attached to the back of hand of the right hand glove. The pad (Cpd) connected to the main portion (M) by wire is contained in the left hand glove portion. The pads (Dpd1, Dpd2) of right hand glove portion is not connected to the main portion by any wire. The main portion (M) contains the signal recognizing portion (Recog) which is connected to the pad (Cpd) of left hand glove portion. If an user clap with the glove so that the pad (Cpd) of left hand glove portion touches with one of pads (Dpd1, Dpd2) of right hand glove portion then the signal generated by signal generators (gen1,gen2) is applied to the signal recognizing portion (Recog) through the touching pads. The signal recognizing portion (Recog) can distinguish which signal is applied to the pad (Cpd) of left hand glove portion through the pads (Dpd1,Dpd2) of right hand glove portion. If the signal is frequency modulated one then the signal recognizing portion (Recog) can recognize the frequency of the signal by using the band pass filter. Such a modulation and demodulation is well known technology. FIG. 17 shows the example of signal recognizing portion (Recog) which contains two band pass filters (Flt1,Flt2) which pass the signal of specific frequency f1,f2 respectively. In other words, 1st band pass filter (Flt1) passes the signal of frequency f1 and stops the other signals and 2nd band pass filter (Flt2) passes the signal of frequency f2 and stops the other signals. The signal passed through the band pass filter is rectified by the touch recognizing portion (Re1,Re2) which is the same as shown in FIG. 11. The microcontroller (M) can generate the key input signal corresponding to the voltage value of the ports (A1,A2). If 1st pad (Dps1) of right hand glove portion touches the (Cpd) of left hand glove portion then signal of frequency f1 passes through only the 1st band pass filter (Filt1) and rectified by the 1st touch recognizing portion (Re1). In this case voltage at A1 is positive non zero and voltage at A2 is zero. Similarly, If the 2nd pad (Dpd2) touches the pad (Cpd) of left hand glove portion then the voltage at A1 is zero and the voltage at A2 is positive non zero. By checking the voltage at A1,A2, the microcontroller can recognize the touching pads and generate the key input signal corresponding to the pair of touching pads.

The frequency modulated signal with band pass filter is just an example so any recognizable signals can be used in this embodiment like amplitude, phase, or code modulated one.

### Embodiment 10

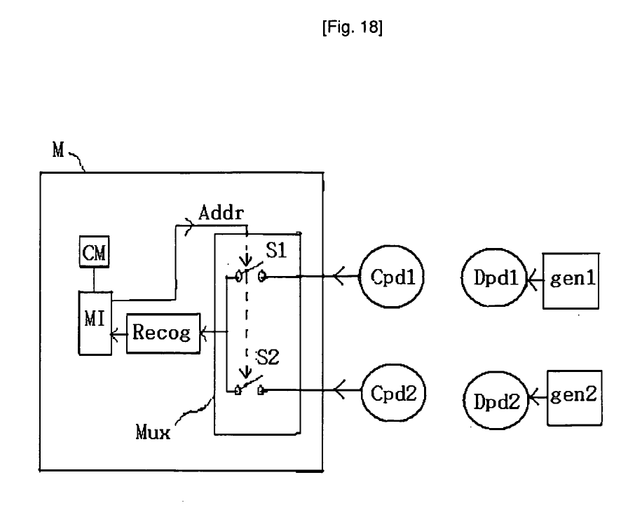

FIG. 18 shows the case of multiple pads (Cpd1,Cpd2) connected to the analog multiplexer (Mux) in main portion (M). The microcontroller (Mi) periodically changes the address signal (Addr) to the analog multiplexer (Mux) so that only one of switch in the analog multiplexer (Mux) is on and the on switch rotates among the switches. In other words, the switch whose state is on changes in time series like: S1, S2, S1, S2, . . . the other function of the circuit in FIG. 18 except such a multiplexing is the same as in embodiment 9. The detail process of FIG. 18. is as following:

(1). The microcontroller (Mi) outputs address signal (Addr) so that only the 1st switch (S1) in analog multiplexer (Mux) is on.

(2). The microcontroller (Mi) reads the output voltages (A1,A2) of the signal recognizing portion (Recog) and if one of the read voltages (A1,A2) is positive then generates the key input signal corresponding to the read voltages (A1,A2).

(3). The microcontroller changes the address signal (Addr) so that only the 2nd switch (S2) in analog multiplexer (Mux) is on.

(4). The microcontroller (Mi) reads the output voltages (A1,A2) of the signal recognizing portion (Recog) and if one of the read voltages (A1,A2) is positive then generates the key input signal corresponding to the read voltages (A1,A2).

(5). Repeat the above process (1)˜(5).

The number of pads per each hand is not limited to 2 but it can be larger than 2 in real implementation. If the number of pads is N then the switches in analog multiplexer are S1, S2, . . . , SN. In that case, the microcontroller changes the address signal so that the switch whose state is on changes in time series like: S1, S2, . . . SN, S1, S2, . . . , SN, S1, . . . and at the same time reads the output voltages (A1, A2, . . . AN) of the signal recognizing portion (Recog).

### Embodiment 11

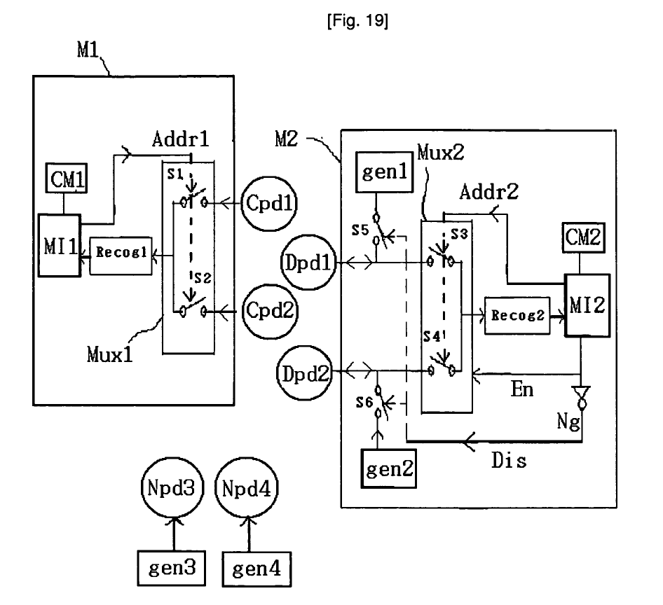

This embodiment is obtained by adding the pads (Npd3, Npd4) of non glove portion and some multiplexers to the embodiment 10 as shown in FIG. 19. The left hand glove portion contains the pads (Cpd1,Cpd2) connected to the 1st main portion (M1) and the right hand glove portion contains the pads (Dpd1,Dpd2) connected to the 2nd main portion (M2). The 1st pad (Cpd1) and 2nd pad (Cpd2) of left hand glove portion are attached to the palm and the back of hand of left hand glove respectively and similarly the 1st pad (Dpd1) and 2nd pad (Dpd2) of right hand glove portion are attached to the palm and the back of hand of right hand glove respectively. The 1st pad (Npd3) and 2nd pad (Npd4) of non glove portion are attached to the left and right knee respectively.

The non glove portion contains a plurality of the pad units. The pad unit is the serially connected set of conducting pad (Npd3, Npd4) and signal generator (gen3, gen4). Two pad units are shown in FIG. 19. The 1st analog multiplexer (Mux1) is contained in the 1st main portion (M1) and the operation of 1st main portion (M1) is the same as the operation of the main portion (M) of the above embodiment 10.

The 2nd microcontroller (Mi2) of 2nd main portion (M2) controls the 2nd analog multiplexer (Mux2) with the enable/disable (En) and address (Addr2) signal. The enable/disable signal (En) is logically inverted by the Not gate (Ng) and applied to the analog multiplexer which contains only one switch (S5, S6). If the 2nd analog multiplexer (Mux2) is enabled then the multiplexers of switches S5, S6 are disabled so that the switches S5, S6 are all Off. Similarly, When the 2nd analog multiplexer (Mux2) is disabled and all the switches in it are off the switches S5,S6 are all On. The 2nd microcontroller (Mi2) periodically changes the enable/disable signal (En) so that the state of 2nd analog multiplexer (Mux2) oscillates between enabled and disabled states. The detail operations in enabled and disabled state of the 2nd analog multiplexer are as following:

(1) Case of Disabled State of 2nd Analog Multiplexer:

In this case, 1st pad (Dpd1) and 2nd pad (Dpd2) of right hand glove portion are connected to 1st signal generator (gen1) and 2nd signal generator (gen2) respectively because all the switches S5,S6 are On. All the signals generated by the 4 signal generators (gen1, gen2, gen3, gen4) can be recognized by 1st signal recognizing portion (Recog1). For example. If the signals are frequency modulated then the frequency of the signals are all different. The 1st microcontroller (Mi1) of the 1st main portion recognizes touching pads by the process described in the above embodiment 10. In this case, the touching occurs between the pads (Cpd1,Cpd2) of left hand glove portion and the other pads (Dpd1,Dpd2,Npd3,Npd4) of right hand glove portion and the non glove portion. If the touching is detected then the 1st microcontroller (Mi1) of the 1st main portion can generate the key input signal corresponding to the detected pair of touching pads. The key input signal can be transmitted to PC or PDA by the 1st communication portion (CM1).

(2) Case of Enabled State of 2nd Analog Multiplexer:

The switches S5, S6 in 2nd main portion (M2) are all off and the pads (Dpd1, Dpd2) of right hand glove portion are selectively connected to the 2nd signal recognizing portion (Recog2) through the switches (S3,S4) in the 2nd analog multiplexer (Mux2). The 2nd microcontroller (Mi2) in 2nd main portion (M2) recognizes the touching pads by the process described in the above embodiment 10. In this case, the touching occurs between the pads (Dpd1, Dpd2) of right hand glove portion and the pads (Npd3,Npd4) of non glove portion. In this case, the pads (Cpd1,Cpd2) of left hand glove portion do not play any role. If the touching is detected then the 2nd microcontroller (Mi2) of the 2nd main portion can generate the key input signal corresponding to the detected pair of touching pads. The key input signal can be transmitted to PC or PDA by the 2nd communication portion (CM2).

### Embodiment 12

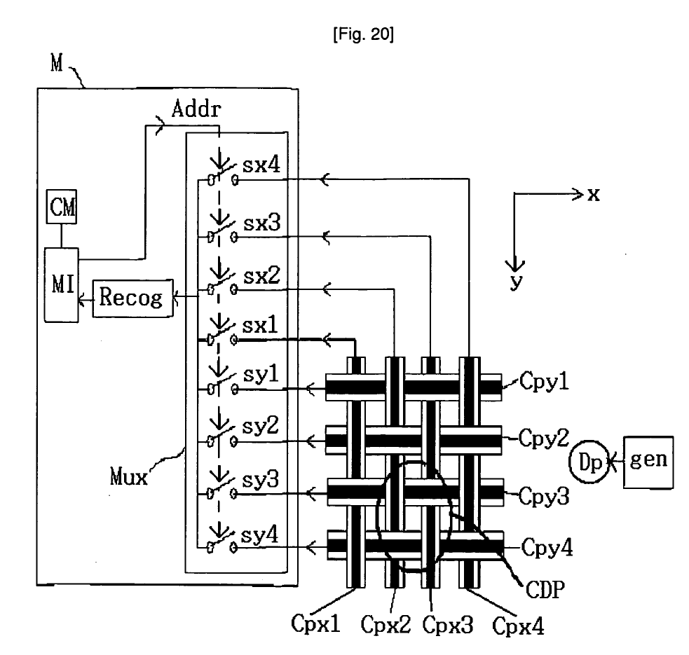

FIG. 20 shows the pointing device of semi wireless mode of present invention. There are many wired pads (Cpx1˜Cpx4,Cpy1˜Cpy4) in texture and one stylus pen type pad (Dp) which is connected to the signal generator (gen). The texture is the same as in FIG. 7. The stylus pen type pad (Dp) connected to the signal generator (gen) is recommanded to attached to the tip (Pf) of pen or finger as shown in FIG. 8. The touching region between the stylus pen type pad (Dp) and the texture is represented as circle (CDP) in FIG. 20. Such a touching region (CDP) can be detected by the microcontroller (Mi) and converted into the mouse pointer coordinate. The detail process is as following: The texture of conducting lines (Cpx1˜Cpx4, Cpy1˜Cpy4) is the same as the embodiment 4 and 8. The conducting lines (Cpx1˜Cpx4, Cpy1˜Cpy4) are selectively connected to the signal recognizing portion (Recog) in main portion through the switches in the analog multiplexer (Mux). The microcontroller (Mi) periodically changes the address signal (Addr) to the analog multiplexer (Mux) so that only one switch in the analog multiplexer is on and the switch which is on rotates. The microcontroller recognizes the conducting line in texture touched with the stylus pen type pad by the same process described in the above embodiment 10. In other words, the conducting lines (Cpx1˜Cpx4, Cpy1˜cpy4) in FIG. 20 correspond to the wired pads (Cpd1, Cpd2) of FIG. 18. And the stylus pen type pad (Dp) in FIG. 20 corresponds to the one of pads (Dpd1, Dpd2) in FIG. 18. The process how to obtain the mouse coordinate from the conducting lines in texture touched with the stylus pen type pad is the same as the embodiment 8.

### Embodiment 13

In the case of embodiments 1,2,3,5,6,7,9,10,11 which do not contain texture type pad, the terminal type pad portion may contains the acceleration or shock sensor. In that case, the microcontroller detects not only the pair of touching pads but also the acceleration or shock value with the sensor. The detected shock or acceleration value can be transmitted to PC or PDA along with the key input signal corresponding the detected pair of touching pads by the communication portion (CM). In order to minimize the number of acceleration or shock sensor, it is recommended to attach the sensor to the glove portion. Such a shock or acceleration value can be used as an input signal to the game program. For example, If an user is playing the drum game which generates the sound of drum by key input signal of the present invention then the volume of the drum sound can be controlled by the shock value of the present invention. By using the present invention for the drum game program, an user can not only play the drum but also dance simultaneously which is good for diet.

By using the input device of present invention, It is possible to lower the price of input device by making the input device with thin conducting pad. The ordinary keyboard or mouse requires very expensive mould. The input device of present invention is possible to wear so that user can use it in any place.

25. An input device of computer, comprising: a pad portion including separately located conducting pads; and a main portion including microcontroller for recognizing the touching pads and generating input signal corresponding to the pair of touching pads.

26. The input device of computer of claim 25, wherein the main portion further comprises a communication portion for communicating the input signal with outer device.

27. The input device of computer of claim 25, wherein the pad portion comprises at least two of the following portions: a right hand glove portion including conducting pads wearable on right hand; a left hand glove portion including conducting pads wearable on left hand; and a non glove portion including conducting pads.

28. The input device of computer of claim 27, wherein the pad portion comprises: 1^{st} pad portion including conducting pads connected to the different input ports of microcontroller of main portion respectively with pull up resistors applied with power voltage; and 2° pad portion including conducting pads connected to the different output ports of microcontroller of main portion respectively, and the main portion including microcontroller for recognizing the touching pads by repeatedly checking the fall of voltage at input ports and at the same time, by repeatedly changing the output pattern which has the output ports of high voltage except only one output port of 0 voltage, wherein the output port of 0 voltage periodically rotates among the output ports.

29. The input device of computer of claim 27, wherein the left glove portion and right glove portion comprise the conducting pads connected to the different bidirectional ports of microcontroller with pull up resistors applied with power voltage; non glove portion comprises conducting pads connected to the different input ports of microcontroller with pull up resistors applied with power voltage; Main portion comprises a microcontroller for recognizing the touching pads by periodically changing the operation mode between 1^{st} mode and 2° mode, wherein the 1^{st} mode is the one in which the bi-directional ports of microcontroller connected to the conducting pads of left hand glove portion operate as output ports and the bi-directional ports of microcontroller connected to the conducting pads of right hand glove portion operate as input ports and the 2° mode is the one in which the bidirectional ports of microcontroller connected to the conducting pads of left hand glove portion operate as input ports and the bidirectional ports connected to the conducting pads of right hand glove portion operate as output ports, by repeatedly checking the fall of voltage at input ports of the given operation mode, and at the same time, by repeatedly changing the output pattern which has the output ports of high voltage except only one output port of 0 voltage wherein the output port of 0 voltage periodically rotates among the output ports of the given operation mode.

30. The input device of computer of claim 27, wherein the left glove portion and right glove portion comprise the conducting pads connected to the different bidirectional ports of microcontroller with pull up resistors applied with power voltage, non glove portion comprises conducting pads connected to the different output ports of microcontroller with pull up resistors applied with power voltage; main portion comprises a microcontroller for recognizing the touching pads By periodically changing the operation mode between 1^{st} mode and 2° mode, wherein the 1^{st} modes the one in which the bi-directional ports of microcontroller connected to the conducting pads of left hand glove portion operate as output ports and the bi-directional ports connected to the conducting pads of right hand glove portion operate as input ports and the 2° mode is the one in which the bidirectional ports of microcontroller connected to the conducting pads of left hand glove portion operate as input ports and the bidirectional ports connected to the conducting pads of right hand glove portion operate as output ports, by repeatedly checking the fall of voltage at input ports of the given operation mode and at the same time, by repeatedly changing the output pattern which has the output ports of high voltage except only one output port of 0 voltage, wherein the output port of 0 voltage periodically rotates among the output ports of the given operation mode.

31. The input device of computer of claim 27, wherein non glove portion comprises conducting pads of texture type; right hand glove portion comprises a conducting pad of stylus pen type; and main portion comprises a microcontroller for recognizing the touching between the stylus pen type conducting pad and the texture type conducting pad and generating the coordinate input signal corresponding to the touching position of the stylus pen type conducting pad on the texture type conducting pad.

32. The input device of computer of claim 31, wherein non glove portion comprises texture which is wove out of thin insulating tape whose one side is coated with conducting material and whose all the coated sides are faced the same side of texture.

33. The input device of computer of claim 32, wherein non glove portion comprises:
Conducting pads which are woofs of texture connected to the different input ports of microcontroller respectively with pull up resistors applied with power voltage;
Conducting pads which are warps of texture connected to the different output ports of microcontroller; and the main portion comprises: Microcontroller for recognizing the touching coordinate whose y coordinate is the index of output port whose output voltage is 0 and whose x coordinate is the input port whose voltage drop is detected by repeatedly checking the fall of voltage at input ports and at the same time, by repeatedly changing the output pattern which has the output ports of high voltage except only one output port of 0 voltage, wherein the output port of 0 voltage periodically rotates among the output ports.

34. The input device of computer of claim 32, wherein the right hand glove portion of stylus pen type comprises: Conducting pad; touch recognizing portion whose input terminal is connected to said conducting pad for outputting trigger signal when the alternating current is detected; RF transmission portion transmitting ID by radio wave when said trigger signal is inputted; and main portion comprises: alternating current power portion for supplying the alternating current power; analog multiplexer whose common terminal is connected to the output terminal of alternating current power portion and whose the other terminals are connected to the conducting pads which are warp and woof of texture of non glove portion; RF receiver portion for receiving the radio wave transmitted from said RF transmission portion and recognizing ID, and Microcontroller for generating input coordinate signal whose x and y coordinate are the indices of conducting pads of warp and woof of texture wherein the indices are selected when said RF receiver portion receives and recognizes ID by periodically rotating the address signal to analog multiplexer so that only one switch in the analog multiplexer is on and the on-switch rotates among the switches.

35. The input device of computer of claim 32, wherein the right hand glove portion of stylus pen type comprises: Conducting pad; signal generator for generating and applying signal to the said conducting pad; and main portion comprises: signal recognizing portion for recognizing the signal; analog multiplexer whose common terminal is connected to the input terminal of signal recognizing portion and whose the other terminals are connected to the different conducting pads respectively which are warp and woof of texture of non glove portion; and microcontroller for generating input coordinate signal whose x and y coordinate are the indices of conducting pads of warp and woof of texture respectively, wherein the indices are selected when said signal recognizing portion recognizes ID by periodically rotating the address signal to analog multiplexer so that only one switch in the analog multiplexer is on and the on-switch rotates among the switches.

36. The input device of computer of claim 35, wherein signal generator includes alternating current power whose frequency is distinguishable so that the frequency of it can be used as ID; signal recognizing portion including plurality of signal recognizing units, wherein said signal recognizing unit includes band pass filter and rectifier to rectify the output signal from the said band pass filter.

37. The input device of computer of claim 27, wherein the pad portion comprises: *1^{st} pad portion including conducting pad connected to the main portion with electric wire and 2° pad portions including a plurality of pad units wherein the pad unit includes conducting pad, touch recognizing portion outputting trigger signal when the alternating current is detected and RF transmission portion transmitting ID by radio wave when the said trigger signal is inputted, wherein said conducting pad is connected to the input terminal of said touch recognizing portion; and main portion comprises: alternating current power portion for supplying the alternating current power to the conducting pad of said 1^{st} pad portion; RF receiver portion for receiving the radio wave transmitted from said RF transmission portion and recognizing ID; and Microcontroller for generating input signal corresponding to the ID recognized by said RF receiver portion.

38. The input device of computer of claim 37, wherein touch recognizing portion comprises: conducting pad connected to one terminal of resistor; and rectifier for rectifying the alternate current between the two terminals of the said resistor.

39. The input device of computer of claim 27, wherein the pad portion comprises: 1^{st} pad portion including a plurality of conducting pads connected to the main portion with electric wire and 2° pad portion including a plurality of pad units wherein the pad unit includes conducting pad, touch recognizing portion outputting trigger signal when the alternating current is detected and RF transmission portion transmitting ID by radio wave when said trigger signal is inputted, wherein said conducting pad is connected to the input terminal of said touch recognizing portion; and main portion comprises: alternating current power portion for supplying the alternating current power; analog multiplexer whose common terminal is connected to output terminal of said alternating current power portion and whose non common terminals are connected to the different conducting pads of said 1^{st} pad portion respectively; RF receiver portion for receiving the radio wave transmitted from said RF transmission portion and recognizing ID; and
Microcontroller for generating input signal corresponding to the ID recognized by said RF receiver portion and the address signal to the analog multiplexer by periodically rotating the address signal to analog multiplexer so that only one switch in the analog multiplexer is on and the on-switch periodically rotates among the switches.

40. The input device of computer of claim 39, wherein touch recognizing portion comprises: conducting pad connected to one terminal of resistor; and rectifier for rectifying the alternate current between the two terminals of the said resistor.

41. The input device of computer of claim 27, wherein the pad portion comprises: a left hand glove portion; a right hand glove portion; and a non glove portion including a plurality of pad units, wherein the pad unit includes conducting pad, touch recognizing portion outputting trigger signal when the alternating current is detected and RF transmission portion transmitting ID by radio wave when said trigger signal is inputted, wherein said conducting pad is connected to the input terminal of said touch recognizing portion; and main portion comprises: 1^{st} main portion connected to the left hand glove portion with electric wire; and 2° main portion connected to the right hand glove portion with electric wire.

42. The input device of computer of claim 41, wherein touch recognizing portion comprises: conducting pad connected to one terminal of resistor; and rectifier for rectifying the alternate current between the two terminals of the said resistor.

43. The input device of computer of claim 41, wherein 1^{st} main portion comprises: 1^{st} alternating current power portion for supplying alternating current power; 1^{st} analog multiplexer whose common terminal is connected to the output terminal of said 1^{st} alternating current power portion and whose non common terminals are connected to the different conducting pads of the left hand glove portion respectively; 1^{st} microcontroller for periodically outputting enable/disable signal to the 1^{st} analog multiplexer; operation mode transmission portion for transmitting said enable/disable signal by the radio wave; and 2° main portion comprises: 2° alternating current power portion for supplying alternating current power; 2° analog multiplexer whose common terminal is connected to the output terminal of said 2° alternating current power portion and whose non common terminals are connected to the different conducting pads of the right hand glove portion respectively; touch recognizing portion outputting trigger signal when the alternating current is detected; RF transmission portion transmitting ID by radio wave when said trigger signal is inputted; analog multiplexer including only one switch whose one terminal is connected to the conducting pad of right hand glove and the other terminal is connected to the input terminal of said touch recognizing portion; operation mode receiver portion for receiving the said enable/disable signal transmitted from said operation mode transmission portion of 1 main portion; 2° microcontroller for periodically changing the enable/disable state of 2° analog multiplexer and the one switched analog multiplexer according to the enable/disable signal received by operation mode receiver portion wherein the enable/disable state of 2° analog multiplexer is always different from the enable/disable state of the one switched analog multiplexer.

44. The input device of computer of claim 43, wherein touch recognizing portion comprises: conducting pad connected to one terminal of resistor; and rectifier for rectifying the alternate current between the two terminals of the said resistor.

45. The input device of computer of claim 43, wherein the 1^{st} main portion comprises: 1^{st} RF receiver portion for receiving the radio wave transmitted from the RF transmission portion of 2° main portion and non glove portion and recognizing ID; *1 microcontroller for generating input signal corresponding to the ID recognized by said 1^{st} RF receiver portion and the address signal to the 1^{st} analog multiplexer by periodically rotating the address signal to the 1^{st} analog multiplexer so that only one switch in the 1^{st} analog multiplexer is on and the on-switch rotates among the switches; 2° main portion comprises: 2° RF receiver portion for receiving the radio wave transmitted from the RF transmission portion of non glove portion and recognizing ID; 2° microcontroller for generating input signal corresponding to the ID recognized by said 2° RF receiver portion and the address signal to the enabled 2 analog multiplexer by periodically rotating the address signal to the 2° analog multiplexer so that only one switch in the 2° analog multiplexer is on and the on-switch rotates among the switches;

46. The input device of computer of claim 45, wherein touch recognizing portion comprises: conducting pad connected to one terminal of resistor; and rectifier for rectifying the alternate current between the two terminals of the said resistor.

47. The input device of computer of claim 27, wherein the pad portion comprises:
1^{st} pad portion including conducting pad connected to the main portion with electric wire and 2° pad portion including a plurality of pad units wherein the pad unit includes conducting pad which is not connected to the main portion with electric wire and includes signal generator which apply distinguishable signal to the said conducting pad; and main portion comprises: signal recognizing portion for recognizing the signal in the conducting pad of 1^{st} pad portion; microcontroller for generating input signal corresponding to recognized signal by signal recognizing portion.

48. The input device of computer of claim 47, wherein signal generator includes alternating current power whose frequency is distinguishable so that the frequency of it can be used as ID; signal recognizing portion including plurality of signal recognizing units, wherein said signal recognizing unit includes band pass filter and rectifier to rectify the output signal from the said band pass filter.

49. The input device of computer of claim 27, wherein the pad portion comprises: 1^{st} pad portion including conducting pads connected to the main portion with electric wire and 2° pad portion including a plurality of pad units wherein the pad unit includes conducting pad which is not connected to the main portion with electric wire and signal generator which applies distinguishable signal to the conducting pad; and main portion comprises: signal recognizing portion for recognizing the signal in the conducting pad of 1^{st} pad portion; analog multiplexer whose common terminal is connected to the input terminal of said signal recognizing portion and whose the other terminals are connected to the conducting pads of the 1^{st} pad portion; and microcontroller for generating input signal corresponding to recognized ID of signal by signal recognizing portion and address signal to the analog multiplexer by periodically rotating the address signal to the analog multiplexer so that only one switch in the analog multiplexer is on and the on-switch rotates among the switches;

50. The input device of computer of claim 49, wherein signal generator includes alternating current power whose frequency is distinguishable so that the frequency of it can be used as ID; signal recognizing portion including plurality of signal recognizing units, wherein said signal recognizing unit includes band pass filter and rectifier to rectify the output signal from the said band pass filter.

51. The input device of computer of claim 27, wherein the pad portion comprises: Left hand glove portion; Right hand glove portion; and Non glove portions including a plurality of pad units wherein the pad unit includes conducting pad which is not connected to the main portion with electric wire and includes signal generator which applies distinguishable signal to the conducting pad; and Main portion comprises: 1^{st} main portion connected to the left hand glove portion with electric wire; and 2° main portion connected to the right hand glove portion with electric wire.

52. The input device of computer of claim 51, wherein signal generator includes alternating current power whose frequency is distinguishable so that the frequency of it can be used as ID; signal recognizing portion including plurality of signal recognizing units, wherein said signal recognizing unit includes band pass filter and rectifier to rectify the output signal from the said band pass filter.

53. The input device of computer of claim 51, wherein 1^{st} main portion comprises: 1^{st} signal recognizing portion for recognizing the signal; 1^{st} analog multiplexer whose common terminal is connected to the input terminal of 1^{st} signal recognizing portion and whose the other terminals are connected to the different conducting pads of left hand glove portion respectively; 1^{st} microcontroller for generating input signal corresponding to recognized ID of signal by 1^{st} signal recognizing portion and address signal to the 1^{st} analog multiplexer by periodically rotating the address signal to the 1^{st} analog multiplexer so that only one switch in the 1^{st} analog multiplexer is on and the on-switch rotates among the switches; and the 2° main portion comprises: signal generators which generate distinguishable signal; analog multiplexers including only one switch whose one terminal is connected to the output terminal of the said signal generator and whose another terminal is connected to the conducting pad of right hand glove portion; 2° signal recognizing portion for recognizing the signal; 2° analog multiplexer whose common terminal is connected to the input terminal of 2″ signal recognizing portion and whose the other terminals are connected to the different conducting pads of right hand glove portion respectively; and 2° microcontroller for periodically changing the enable/disable state of 2° analog multiplexer and the one switched analog multiplexer wherein the enable/disable state of 2nd analog multiplexer is always different from the enable/disable state of the one switched analog multiplexer.

54. The input device of computer of claim 53, wherein signal generator includes alternating current power whose frequency is distinguishable so that the frequency of it can be used as ID; signal recognizing portion including plurality of signal recognizing units, wherein said signal recognizing unit includes band pass filter and rectifier to rectify the output signal from the said band pass filter.
